(19) United States
(12) Patent Application Publication
(10) Pub. No.: US 2010/0192059 A1
(43) Pub. Date: Jul. 29, 2010

(54) DISPLAY APPARATUS, DISPLAY METHOD AND COMPUTER-READABLE RECORDING MEDIUM IN WHICH DISPLAY PROCESSING PROGRAM IS RECORDED

(75) Inventor: Hiroki Sugamata, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogya Kabushiki Kaisha, Nagoya-shi (JP)

(21) Appl. No.: 12/693,551

(22) Filed: Jan. 26, 2010

(30) Foreign Application Priority Data
Jan. 26, 2009 (JP) 2009-014687

(51) Int. Cl. G06F 17/00

(52) U.S. Cl. 715/251

(57) ABSTRACT

A display apparatus includes a reading and display device configured to read contents selected based on instructions from a nonvolatile portable storage device that can rewrite storage content and is removable, and to cause a display device to display the contents; a display switching device configured to switch a page of the contents being displayed by the display device based on the instructions; and a storage control device configured to cause the portable storage device to store display page information indicating the page displayed immediately before an end of a display of the selected contents, in correspondence with the contents, at a predetermined timing. The reading and display device reads the display page information corresponding to the selected contents from the portable storage device, and causes the display device to display the page indicated by the display page information.

The entire disclosure of the Japanese Patent Application No. 2009-14687, including the specification, the scope of claims, drawings, and abstract, filed on Jan. 26, 2009 is incorporated herein by reference in its entirety.

### BACKGROUND OF THE INVENTION

1. Field of the Invention

The present invention relates to a technical field of a display apparatus, a display method, and a computer-readable recording medium in which a display processing program is recorded, that display contents in unit of page.

2. Description of the Related Art

Currently, display apparatuses to browse contents such as electronic documents are widely known. In such a display apparatus, a plurality of contents can be generally displayed while being switched by user's operations. In such an aspect, there is inconvenience in that time and effort are needed for a user to reach a page which the user browsed last time, if the first page of contents is displayed each time the contents are switched.

To overcome such inconvenience, there is known a display apparatus that stores the last display page read by a user for contents that are stored in a memory card or the like and browsed therefrom in a management table as an already-read page, and acquires information about the already-read page of contents selected from a menu to display the already-read page of the contents.

### SUMMARY OF THE INVENTION

However, a conventional display apparatus has a management table stored in an apparatus body, and thus, when a memory card or the like in which contents are stored is inserted into another apparatus to browse the contents, the contents cannot be displayed from the already-read page.

Thus, the present invention has been made in view of the above circumstances, and an object thereof is to provide a display apparatus, a display method, and a computer-readable recording medium in which a display processing program is recorded, being capable of displaying a page displayed immediately before the end of the display of contents last time, even if the contents which have been browsed by a user is browsed in another display apparatus.

In order to solve the above problem, an aspect of the invention is a display apparatus, comprising:

a display device configured to display contents constituted by a plurality of pages;

an input device configured to be used to input instructions;

a reading and display device configured to read the contents selected based on the instructions, from a nonvolatile portable storage device that can rewrite storage contents and is removable, and to cause the display device to display the contents;

a display switching device configured to switch a page of the contents being displayed by the display device based on the instructions; and

a storage control device configured to cause the portable storage device to store display page information indicating the page displayed immediately before an end of a display of the selected contents, in correspondence with the contents, at a predetermined timing,

wherein the reading and display device reads the display page information corresponding to the selected contents from the portable storage device, and causes the display device to display the page indicated by the display page information.

### BRIEF DESCRIPTION OF THE DRAWINGS

FIG. 1 is a block diagram exemplifying an outlined configuration of a portable display apparatus 1 according to an embodiment.

FIG. 2 is a diagram exemplifying a data configuration of contents stored in a memory card MC in a first embodiment.

FIGS. 3A to 3J are diagrams exemplifying the transitions of screen when contents A and contents B are displayed on a screen by switching the contents A and the contents B.

FIG. 4 is a flow chart exemplifying a process performed by a CPU 101 in a portable display apparatus 1 according to the first embodiment.

FIG. 5 is a flow chart exemplifying a process performed by a CPU 101 in a portable display apparatus 1 according to the first embodiment.

FIGS. 6A to 6C are diagrams exemplifying the transitions of screen when a third page of the contents B is displayed in an enlarged condition.

FIG. 7 is a diagram exemplifying a data configuration of contents stored in a memory card MC in a second embodiment.

FIG. 8 is a flow chart exemplifying a process performed by a CPU 101 in a portable display apparatus 1 according to the second embodiment.

FIG. 9 is a flow chart exemplifying a process performed by a CPU 101 in a portable display apparatus 1 according to the second embodiment.

### DETAILED DESCRIPTION OF THE PREFERRED EMBODIMENTS

Preferred embodiments of the present invention will be described below, with reference to the drawings. Embodiments described below are embodiments when the present invention is applied to a portable display apparatus that displays contents such as electronic documents stored in a memory card, which is a nonvolatile portable storage device (a recording medium) in which storage contents can be rewritten and which is removable, such as an SD (Secure Digital) memory card and a multimedia card.

### 1. First Embodiment

### 1.1 Configuration of Portable Display Apparatus

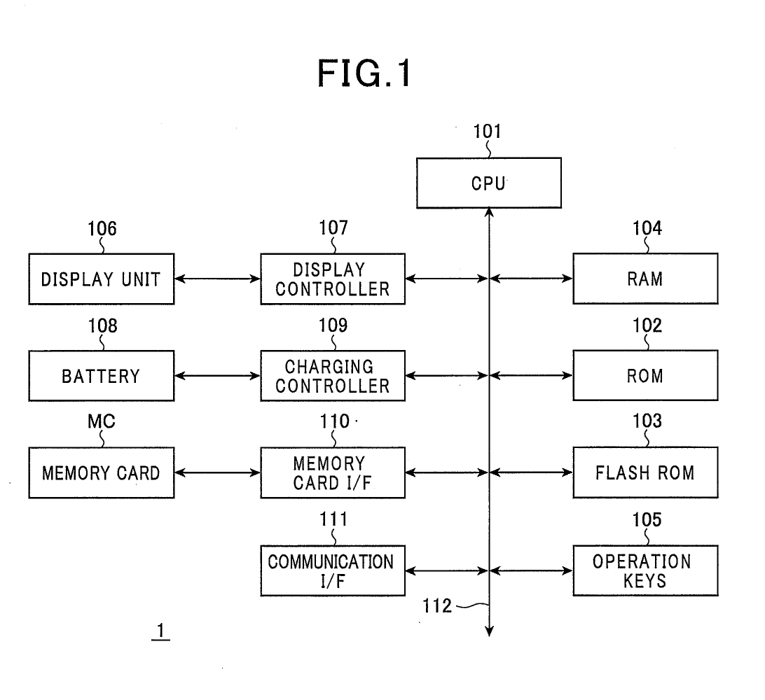

First, a configuration and a function of a portable display apparatus 1 according to a first embodiment of the present invention will be described with reference to FIGS. 1, 2, and 3A to 3J.

As shown in FIG. 1, a portable display apparatus 1 is configured by a CPU (Central Processing Unit) 101 that supervises the whole portable display apparatus 1, a ROM (Read Only Memory) 102 that stores firmware and the like, a flash ROM 103 that stores data such as various control programs and user settings, a RAM (Random Access Memory) 104 that temporarily stores data necessary for a control process of the CPU 101 as a volatile storage device, a cursor key, a decision key, a power switch, and the like, and the portable display apparatus 1 is provided with operation keys 105 that supply instructions from a user as instructions information to the CPU 101 as an input device, a display unit 106 that is configured by, for example, an electrophoretic display panel and displays contents on a screen, and a display controller 107 that controls a display by the display unit 106 based on instructions from the CPU 101.

The portable display apparatus 1 is also configured by a battery 108 that is configured by, for example, lithium ion batteries and supplies power to each unit, a charging controller 109 that controls the charging of the battery 108, and a memory card drive or the like, and the portable display apparatus 1 is provided with a memory card I/F (interface) 110 that writes data to or reads data from a memory card MC inserted in the memory card drive based on instructions from the CPU 101, and a communication I/F 111 that performs an interface process to transmit and receive data by connecting the portable display apparatus 1 to an external apparatus such as a personal computer by wire or by radio. Moreover, the CPU 101, the ROM 102, the flash ROM 103, the RAM 104, the operation keys 105, the display controller 107, the charging controller 109, the memory card I/F 110, and the communication I/F 111 are connected to each other through a bus 112.

Each of contents is stored in the memory card MC, for example, with one of contents being as contents information composed of one file. Each of contents is configured by header information (an example of additional information), and actual data.

The header information is added to contents as information about contents themselves. More specifically, for example, contents ID as identification information of contents, title information indicating the title of contents, the total number of pages of contents, the reading date/time of contents (date/time when displayed last), and the reading page number (an example of display page information) indicating the number of page being read by a user are set, as header information. The reading page number is a page number displayed when a display of contents opened (displayed on a screen) ended or power was turned off. An area where header information is set (an example of an additional area) is reserved in contents information in advance. Therefore, neither reading date/time nor reading page number is set to contents that have never been browsed (displayed), and in that case, invalid values are set to such area.

Actual data is a body of contents displayed on a screen. For example, the actual data is arranged in such a way that bitmap data as display images is configured by being divided for each page.

Contents of such configuration are created, for example, based on the conversion of original contents performed by a personal computer or the like. The created contents are stored in a memory card MC by a personal computer or the like, or stored in a memory card MC after being received by a personal computer or the like via the communication I/F 111.

The CPU 101 performs a selection process of contents and a display control process thereof, by reading and executing various programs (including a display processing program according to the present invention) stored in the ROM 102 or the flash ROM 103, and functions as a display control device, a display switching device, a storage control device, and the like according to the invention.

More specifically, the CPU 101 reads actual data of contents selected by a user from a content list to select contents to be displayed on a screen, from a memory card MC, and causes the actual data to be displayed on a screen. At this time, the CPU 101 reads header information of the selected contents from the memory card MC. If a reading page number is registered in the header information, the CPU 101 causes a page indicated by the reading page number to be displayed on a screen, and if no reading page number is registered, the CPU 101 causes the first page to be displayed. Then, regardless of whether a reading page number is registered in the header information, the CPU 101 causes the number of displayed page to be stored in the RAM 104 as a display page number.

The CPU 101 also causes a page for displaying a screen of currently opened contents to be switched to another page for displaying, in accordance with a page switching operation of a user. At this time, the CPU 101 makes reference to a display page number stored in the RAM 104 to recognize the page currently displayed, and to change the display page number. Then, when an operation to close contents is performed by a user (instructions to terminate the display of contents are provided by a user), the CPU 101 records a page number displayed on a screen at that time, that is, a display page number stored in the RAM 104 in header information of contents stored in the memory card MC (opened at that time), as a reading page number.

An example of screen transition by the above process will be described.

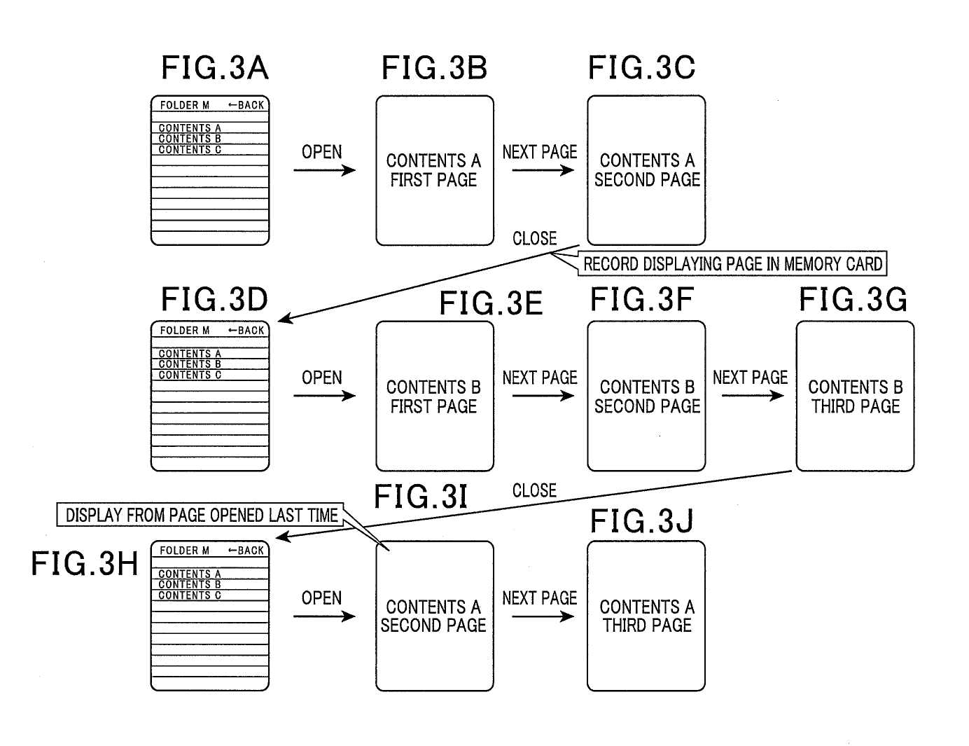

FIG. 3A is an example of display, on a screen, of the contents list. FIG. 3A shows that contents A, contents B, and contents C are stored in a folder M (or a directory) of the memory card MC. If the contents A are selected for the first time, the first page of the contents A is displayed on the screen (FIG. 3B). Then, the second page of the contents A is displayed on the screen by an operation to switch to the next page (FIG. 3C). The screen returns to a display of the listing of contents by an operation to close the contents (FIG. 3D), and the number of the page “2” displayed at this time is stored in the memory card MC as the reading page number.

After that, when the contents B is selected for the first time, the first page of the contents B is displayed in the screen (FIG. 3E), and the second page of the contents B, and the third page of the content B are successively displayed on a screen by an operation to switch to the next page (FIG. 3F, and FIG. 3G). The screen returns to a display of the listing of contents again by an operation to close the contents (FIG. 3H). Here, if the contents A are selected, the second page of the contents A displayed at the last time is displayed on a screen (FIG. 3I). The third page of the contents A is displayed on a screen by an operation to switch to the next page (FIG. 3J).

When a power-off operation is performed, in addition to the case where contents are closed, the CPU 101 stores the number of the page displayed on a screen at that time in header information of the contents stored in the memory card MC (opened at that time) as the number of the reading page. In the present embodiment, the power-off operation is an operation to cause the stop of power supply to all devices in the portable display apparatus 1. If the display unit 106 is, for example, a volatile display device such as a cathode ray tube or liquid crystal display, a power-off operation to stop the power supply from the battery 108 directly means the termination of the display of contents. But, if the display unit 106 is, like the present embodiment, electronic paper of an electrophoretic system or the like, a display up to that time can be maintained even in a power-off state. On the other hand, if the displaying page number is stored in the RAM 104, the information will disappear. Thus, in the present embodiment, the reading page number is caused to be stored immediately before power is turned off when a power-off operation is performed.

A control program stored in the flash ROM 103 may be, for example, stored in the memory card MC, and updated via the memory card I/F 110, or received and updated via the communication I/F 111.

### 1.2 Operation of Portable Display Apparatus

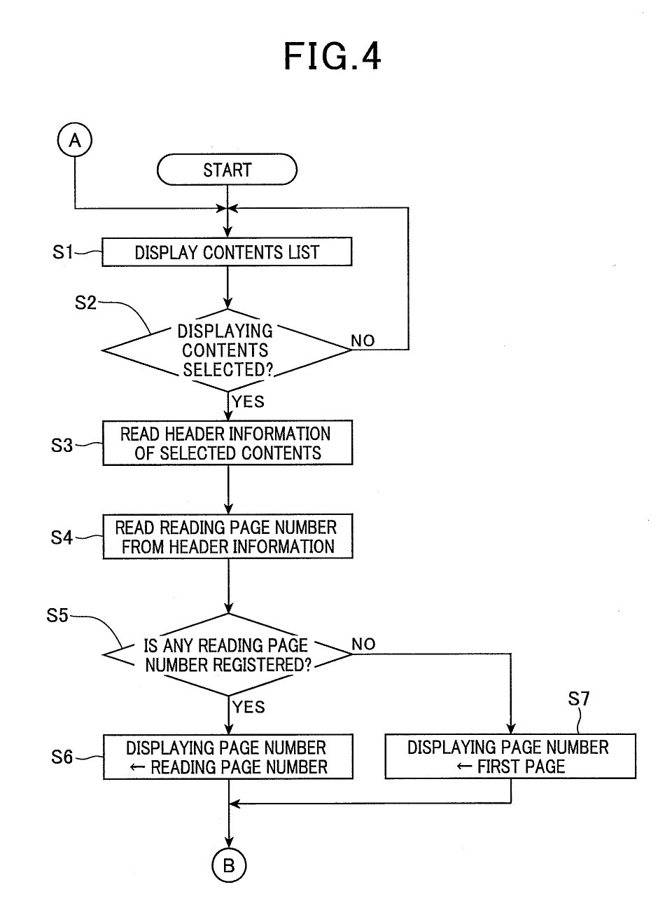

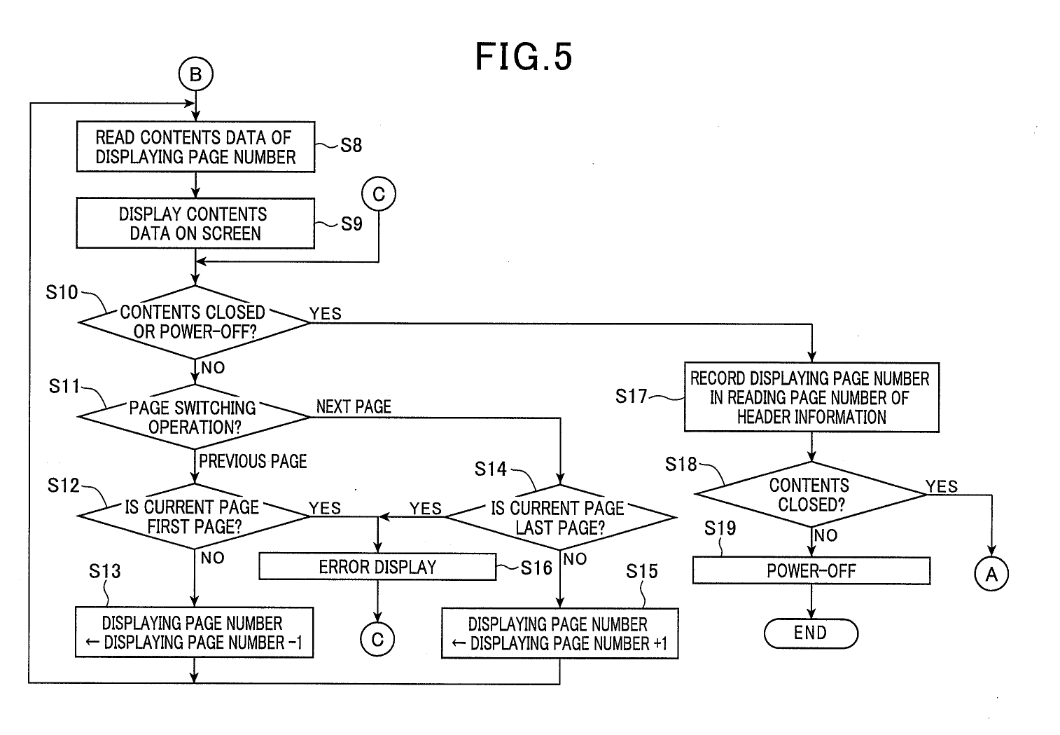

An operation of a portable display apparatus 1 according to the present embodiment will be described with reference to FIGS. 4 and 5.

Processing shown in FIG. 4 is started, for example, after power of the portable display apparatus 1 is turned on. First, the CPU 101 reads header information of each of contents stored in the memory card MC inserted into a memory card drive, and causes a contents list to be displayed on a screen, for example, as shown in FIG. 3A, based on the header information (step S1). Then, the CPU 101 determines whether contents to be displayed have been selected by a user based on instructions information from the operation keys 105 (step S2). At this time, if no contents have been selected (step S2: NO), the CPU 101 moves to step S1.

On the other hand, if contents have been selected (step S2: YES), the CPU 101 reads header information of the selected contents from the memory card MC (step S3), and reads the reading page number from the header information (step S4). The CPU 101 determines whether any reading page number is registered (step S5). At this time, if a reading page number is registered (step S5: YES), the CPU 101 sets the reading page number as the displaying page number (step S6), and if no reading page number is registered (step S5: NO), the CPU 101 sets the first page as the displaying page number (step S7).

When the setting of the displaying page number is completed, the CPU 101 reads actual data of the page indicated by the displaying page number of the selected contents from the memory card MC (step S8), and causes the actual data to be displayed on a screen (step S9).

Then, the CPU 101 determines whether an operation to close the contents or a power-off operation has been performed by a user based on instructions information from the operation keys 105 (step S10). At this time, if neither an operation to close the contents nor a power-off operation has been performed (step S10: NO), the CPU 101 determines the contents of a page-switching operation by a user (step S11).

If an operation of switching to the previous page is performed (step S11: Previous page), the CPU 101 determines whether the current display page is the first page (step S12). At this time, if the current display page is not the first page (step S12: NO), the CPU 101 subtracts “1” from the current display page number (step S13), and moves to step S8 to switch a display of screen to the previous page. On the other hand, if the current display page is the first page (step S12: YES), the CPU 101 causes an error message to be displayed on a screen (step S16), and moves to step S10.

If an operation of switching to the next page is performed at step S11 (step S11: Next page), the CPU 101 determines whether the current display page is the last page (step S14). At this time, if the current display page is not the last page (step S14: NO), the CPU 101 adds “1” to the number of the current display page (step S15), and moves to step S8 to switch a display of screen to the next page. On the other hand, if the current display page is the last page (step S14: YES), the CPU 101 causes an error message to be displayed on a screen (step S16), and moves to step S10.

If an operation to close the contents or a power-off operation has been performed at step S10 (step S10: YES), the CPU 101 records the current display page number in the memory card MC as the reading page number of header information of the selected contents (step S17).

Then, the CPU 101 determines whether a user operation is an operation to close the contents (step S18). At this time, if the user operation is an operation to close the contents (step S18: YES), the CPU 101 moves to step S1 to display a contents list. On the other hand, if the user operation is a power-off operation (step S18: NO), the CPU 101 turns the power off (step S19), so that the present process terminates.

According to the present embodiment, as described above, the CPU 101 reads contents selected based on instructions information from the operation keys 105 from the memory card MC to cause the display unit 106 to display the contents, switches a page of the contents being displayed in the display unit 106 based on the instructions information from the operation keys 105, causes the memory card MC to store the reading page number indicating a page displayed immediately before the end of the display of the selected contents by associating with the contents in a predetermined timing, reads the reading page number corresponding to the contents next selected from the memory card MC, and causes a page indicated by the reading page number to be displayed. Therefore, by installing the memory card MC in the display apparatus 1 having a configuration similar to that of the portable display apparatus 1, a page displayed immediately before the end of the last display can be first displayed also when the same contents are displayed in the other display apparatus.

The CPU 101 records reading page numbers in header information of contents stored in the memory card MC, and therefore, there is no need to reserve an area of a table in which reading page numbers are to be stored in advance, and thus, the number of reading page numbers which can be stored is not limited by the capacity of the table, so that reading page numbers for all contents stored in the memory card MC can be stored. If a size of table size is increased, the capacity of the memory card MC is pressed according to such increase, and it also takes longer to retrieve information set to the table. But, if reading page numbers are recorded in header information, the capacity of the memory card MC is not pressed from the first, and the processing time is not delayed. Further, an area where reading page numbers are set is present in header information in advance, and thus, even if a free space in the memory card MC is zero, reading page numbers can be stored in the memory card MC.

When the CPU 101 terminates the display of the selected contents, a reading page number indicating a page which the display unit 106 displays at that time is stored, and therefore, the reading page number is not stored in the memory card MC each time the page is switched, so that the life of the memory card MC whose number of writings is limited can be prolonged.

When power of the CPU 101 is turned off, the reading page number indicating a page displayed by the display unit 106 at that time is stored. Therefore, when the same contents are displayed by the other display apparatus, the page displayed during power-off can be displayed first by inserting the memory card MC into the other display apparatus, if the display unit 106 is an electrophoretic display that maintains the display of contents even after the power supply from a power source is stopped, and even if the power is turned off without terminating the display of contents. Moreover, the reading page number is not stored in the memory card MC each time a page is switched, so that the life of the memory card MC whose number of writings is limited can be prolonged.

The CPU 101 causes the RAM 104 to store the display a page number indicating a page currently being displayed in a power-on state in which power is supplied to the RAM 104, and causes the memory card MC to store the display page number stored in the RAM 104 as the reading page number immediately before the power supply to all devices including the RAM 104 is stopped by power-off, and therefore, the life of the memory card MC can be prolonged, and the writing time of the display page number can be also shortened in the power-on state, enabling efficient control of the page being read.

### 2. Second Embodiment

Now, a second embodiment of the present invention will be described.

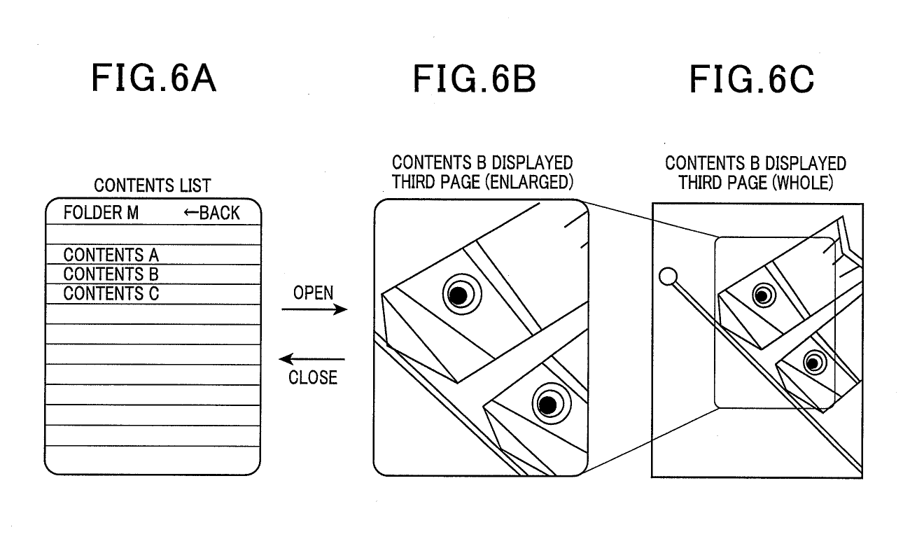

In the present embodiment, the portable display apparatus 1 is arranged to display the contents in an enlarged condition in accordance with a user's operation. The portable display apparatus 1 also records a page last displayed before a display of the contents is terminated, and the state of enlargement. When the same contents are re-displayed, the same page of the contents is displayed with the same state of enlargement. As shown in FIGS. 6A to 6C, for example, a portion of the third page (FIG. 6C) of the contents B is displayed in a state of enlargement (FIG. 6B) due to the fact that the contents B are selected from a contents list (FIG. 6A), and a page-switching operation and an enlargement operation are performed. If the contents B are closed (or power is turned off) once in this state, and then, the contents B are re-selected, the third page that is the page displayed at the time of closing is displayed, and the contents B are displayed at the same enlargement position with the same enlargement ratio (FIG. 6B).

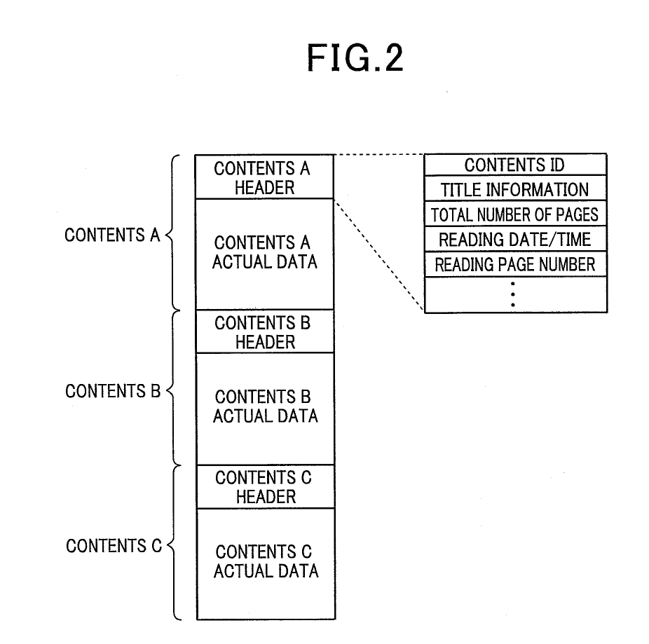

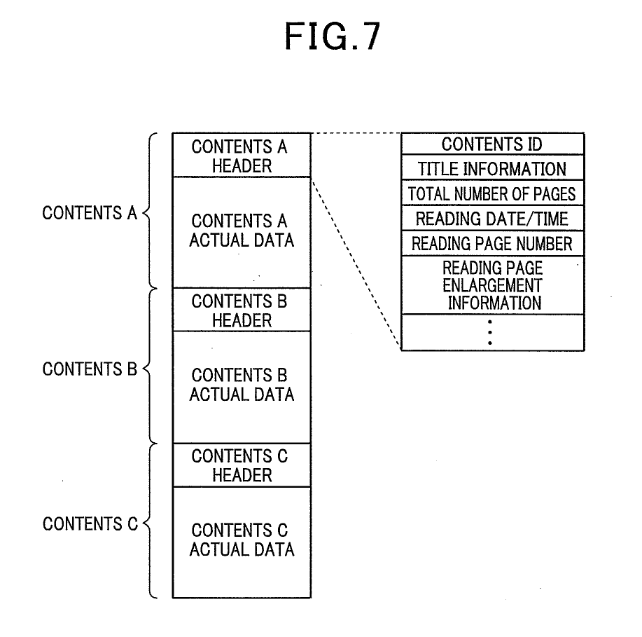

FIG. 7 is different from FIG. 2 in that reading page enlargement information (an example of display information) is added to header information. The reading page enlargement information includes, for example, the enlargement ratio and enlargement position. The display magnification with respect to the normal display, for example, is set as the enlargement ratio. The enlargement position is, for example, the position of the uppermost and leftmost portion of a range displayed on the screen of the first page of contents, and is represented by XY coordinates in which the uppermost and leftmost portion of the first page of contents is set to the origin, at the time of display in an enlarged condition.

If a reading page number is registered in header information of the selected contents when the CPU 101 causes actual data of the contents selected by a user from a contents list to be displayed on a screen, the CPU 101 causes a page indicated by the reading page number to be displayed, and also causes the page to be displayed at the enlargement position with the enlargement ratio indicated by reading page enlargement information.

The CPU 101 also causes the contents to be displayed on a screen by changing the enlargement ratio and enlargement position of the page currently displayed in accordance with an enlargement operation by a user. Then, when an operation to close the contents or a power-off operation is performed by a user, the CPU 101 records the number of the page displayed on a screen at that time as the reading page number, and also records the state of enlargement at that time as the reading page enlargement information.

The configuration of the portable display apparatus 1 is the same as in the first embodiment, so a detailed description thereof will be omitted.

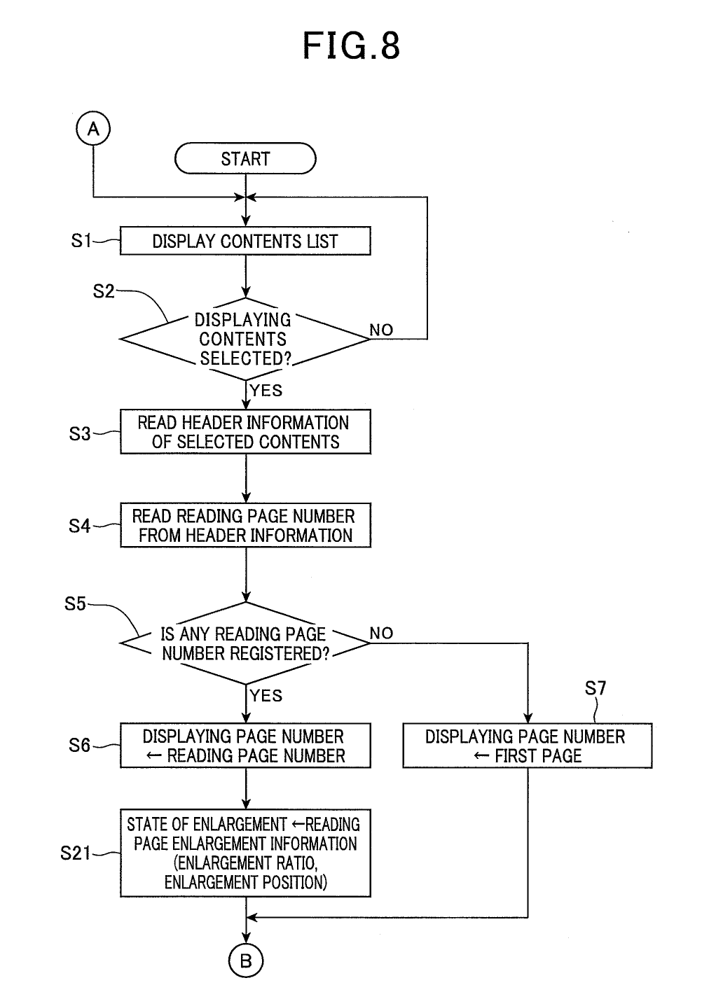

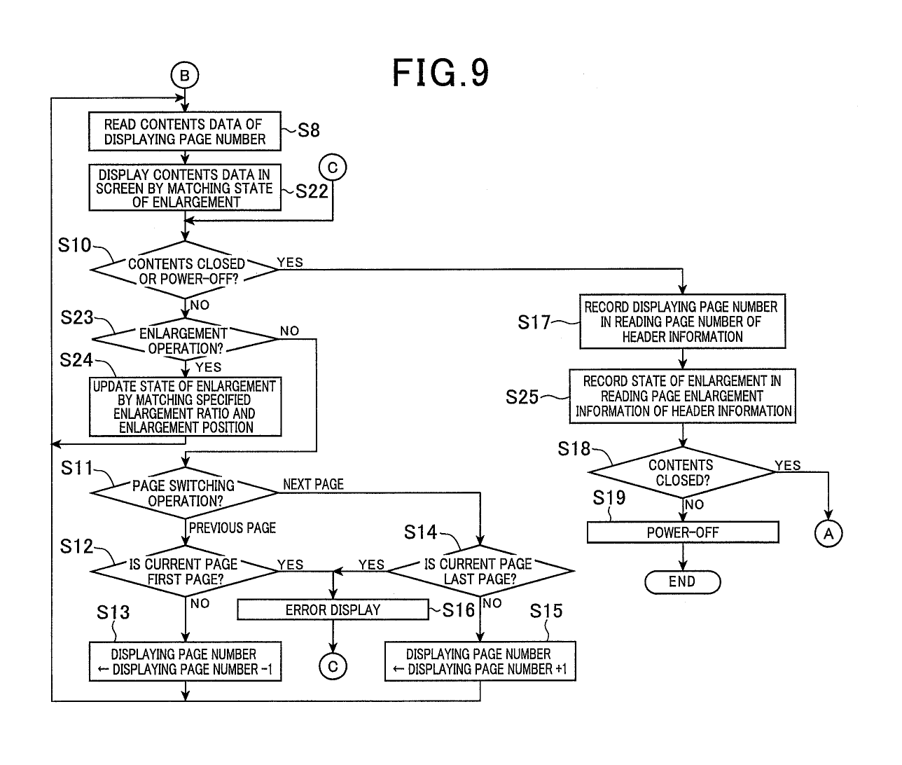

In FIGS. 8 and 9, the same reference numerals are attached to components similar to those in FIGS. 4 and 5.

As shown in FIG. 8, the CPU 101 displays a contents list and reads header information and the reading page number of the selected contents (steps S1 to S4), and if a reading page number is registered (step S5: YES), the reading page number is set as the display page number (step S6), and then, page enlargement information in the header information is set as the display state (step S21). After that, the CPU 101 reads actual data of the page indicated by the displaying page number (step S8), and then, performs an enlarged display or a normal display of the actual data in a matched condition with the current state of enlargement (step S22). If no reading page number is registered (step S5: NO), the CPU 101 performs a normal display.

Then, if neither an operation to close the contents nor a power-off operation has been performed (step S10: NO), the CPU 101 determines whether an enlargement operation has been performed by a user (step S23). At this time, if no enlargement operation has been performed (step S23: NO), the CPU 101 performs a page-switching operation in accordance with a user's operation (steps S11 to S16). On the other hand, if an enlargement operation has been performed (step S23: YES), the CPU 101 updates the current state of enlargement with the enlargement ratio and enlargement position specified by a user (step S24), and the CPU 101 moves to step S8 to reflect the enlargement operation on a display of screen.

If an operation to close the contents or a power-off operation is performed at step S10 (step S10: YES), the CPU 101 records the reading page number (step S17), and also records the current enlargement information as the reading page enlargement information of header information of the selected contents in the memory card MC (step S24). Then, the CPU 101 causes a contents list to be displayed in accordance with the contents of operation, or turns the power off (steps S18, S19, and S1).

According to the present embodiment, as described above, in addition to the effects produced by the first embodiment, the CPU 101 switches at least one of the display enlargement ratio of contents by the display unit 106, and the enlargement position indicating the position of one page of the contents displayed by the display unit 106 based on instructions information from the operation keys 105, causes the memory card MC to store the reading page number, and the reading page enlargement information including the enlargement ratio and enlargement position immediately before the end of the display of the selected contents, reads the reading page number and reading page enlargement information from the memory card MC, causes the screen to display the enlargement position included in the reading page enlargement information in the page indicated by the reading page number with the enlargement ratio included in the reading page enlargement information, and therefore, the page displayed immediately before the end of the last display can be displayed at the enlargement position with the enlargement ratio at that time.

While only the enlargement display of contents is described in the present embodiment, it is possible to apply to a reduction display.

While the reading page number (and reading page enlargement information) are recorded in header information of content in each of the above embodiments, they may be recorded in the memory card MC as separate data (a separate file) from the contents by associating with the contents. A table for management may be provided in a recording area of the memory card MC, so that reading page numbers are set to and recorded in the table. For example, when the memory card MC is inserted into the portable display apparatus 1 for the first time, the CPU 101 reserves an area for the table in the memory card MC. Then, the CPU 101 sets the reading page number and the contents ID of opened contents in a corresponding condition in the table. When the contents are read from the memory card MC next time, the CPU 101 retrieves the table using the contents ID of the contents to read the corresponding reading page number.

While contents is displayed in unit of one page in each of the above embodiments, contents may be displayed in unit of a plurality of pages.

Further, for example, a liquid crystal display or the like may be used as the display unit 106.

Further, for example, each time a page displayed in the display unit 106 is switched, the page number of page displayed at that time may be recorded as the reading page number.

Further, while the reading page number is recorded at the time of power-off that causes the stop of power supply to all devices in the portable display apparatus 1 in each of the above embodiments, the reading page number may be recorded when changing to a power-saving state. Here, the power-saving state is a state in which at least a power supply to the RAM 104 is stopped, and power is supplied to some devices (for example, the CPU 101). For example, if a user does not operate the operation keys 105 for a fixed period of time in a power-on state, the portable display apparatus 1 moves to the power-saving state, and the power supply to some devices is stopped. Accordingly, power consumption of the portable display apparatus 1 can be controlled.

More specifically, if the CPU 101 determines that it is a power-saving state, the CPU 101 causes the stop of power supply from the battery 108 to, for example, the RAM 104 and the display unit 106 immediately after causing the memory card MC to store the display page number stored in the RAM 104 as the reading page number. Then, the CPU 101 monitors the output of instructions information from the operation keys 105 in the power-sating state, and when a power switch or the like is operated, the CPU 101 causes the start of power supply to the RAM 104 and the display unit 106.

The present invention is not confined to the configuration listed in the foregoing embodiments, but it is easily understood that the person skilled in the art can modify such configurations into various other modes, within the scope of the present invention described in the claims.

What is claimed is:

1. A display apparatus, comprising:
a display device configured to display contents constituted by a plurality of pages;
an input device configured to be used to input instructions;
a reading and display device configured to read the contents selected based on the instructions, from a nonvolatile portable storage device that can rewrite storage contents and is removable, and to cause the display device to display the contents;
a display switching device configured to switch a page of the contents being displayed by the display device based on the instructions; and
a storage control device configured to cause the portable storage device to store display page information indicating the page displayed immediately before an end of a display of the selected contents, in correspondence with the contents, at a predetermined timing,
wherein the reading and display device reads the display page information corresponding to the selected contents from the portable storage device, and causes the display device to display the page indicated by the display page information.

2. The display apparatus according to claim 1,
wherein the portable storage device stores the contents to which information about the contents themselves is added as additional information, and
the storage control device sets the display page information into the additional information added to the selected contents stored in the portable storage device.

3. The display apparatus according to claim 1,
Wherein the display switching device switches at least one of a display magnification of the contents by the display device and a range of one page of the contents displayed by the display device based on the instructions,
the storage control device causes the portable storage device to store the display page information, and display information indicating the display magnification and the range immediately before the end of the display of the selected contents, and
the reading and display device reads the display page information and the display information from the portable storage device, and causes the display device to display the range indicated by the display information in the page indicated by the display page information, with the display magnification indicated by the display information.

4. The display apparatus according to claim 1,
Wherein when the display of the selected contents is terminated, the storage control device causes the portable storage device to store the display page information indicating the page displayed by the display device at that time.

5. The display apparatus according to claim 1,
Wherein when a power supply to the display device from a power source is stopped, the storage control device causes the portable storage device to store the display page information indicating the page displayed by the display device at that time.

6. The display apparatus according to claim 1, further comprising:
a volatile storage device to which power for maintenance of storage is supplied from a power source,
wherein when the power is supplied to the volatile storage device, the storage control device causes the volatile storage device to store displaying page information indicating the page being displayed by the display device, and causes the portable storage device to store the displaying page information stored in the volatile storage device as the display page information before a power supply to the volatile storage device is stopped.

7. A computer-readable recording medium in which a display processing program is recorded, the display processing program causing a computer contained in a display apparatus including a display device configured to display contents constituted by a plurality of pages, and an input device configured to be used to input instructions, to function as:
a reading and display device configured to read the content selected based on the instructions, from a nonvolatile portable storage device that can rewrite storage contents and is removable, and to cause the display device to display the contents;
a display switching device configured to switch a page of the contents being displayed by the display device based on the instructions; and
a storage control device configured to cause the portable storage device to store display page information indicating the page displayed immediately before an end of a display of the selected contents, in correspondence with the contents, at a predetermined timing,
wherein the computer as the reading and display device reads the display page information corresponding to the selected contents from the portable storage device, and causes the display device to display the page indicated by the display page information.

8. A display method for a display apparatus including a display device configured to display contents constituted by a plurality of pages, and an input device configured to be used to input instructions, comprising:
a reading and display process of reading the content selected based on the instructions from a nonvolatile portable storage device that can rewrite storage contents and is removable, and causing the display device to display the contents;
a display switching process of switching a page of the contents being displayed by the display device based on the instructions; and
a storage process of causing the portable storage device to store display page information indicating the page displayed immediately before an end of a display of the selected contents, in correspondence with the contents, in at a predetermined timing, wherein the display page information corresponding to the selected contents is read from the portable storage device, and the display device is caused to display the page indicated by the display page information, in the reading and display process.
